(19) United States
(12) Patent Application Publication
(10) Pub. No.: US 2026/0087518 A1
(43) Pub. Date: Mar. 26, 2026

(54) Generating User Interface by Joint Content Selection from Different Selection Processes

(71) Applicant: Maplebear Inc., San Francisco, CA (US)

(72) Inventors: Angadh Singh, Dublin, CA (US); Yunzhi Ye, Bothell, WA (US); Gregory Renner, Silverthorne, CO (US); Shiyu Wei, Fremont, CA (US); Chuanwei Ruan, Sunnyvale, CA (US); Jingying Zhou, San Francisco, CA (US); Taesik Na, Issaquah, WA (US); Sharath Rao Karikurve, Berkeley, CA (US); Tejaswi Tenneti, San Carlos, CA (US); Wenjie Tang, Ontario (CA); Santhosh Kumar Sasanapuri, Mountain View, CA (US); Rishikesh Yardi, Seattle, WA (US)

(21) Appl. No.: 19/248,377

(22) Filed: Jun. 24, 2025

Related U.S. Application Data
(60) Provisional application No. 63/698,987, filed on Sep. 25, 2024.

(51) Int. Cl. G06Q 30/0251; G06Q 30/0273

(52) U.S. Cl. CPC G06Q 30/0255; G06Q 30/0275

(57) ABSTRACT

An online system selects content for placement in positions of a display on a user device. The online system selects a first set of content items according to a first content selection process and a second set of content items according to a second content selection process. To combine the different sets of content items dynamically, the first set of content items and second set of content items are evaluated by a joint impression scoring that includes factors prioritizing user, intrinsic, and other values. The respective contribution by the different factors may be adjusted by one or more adjustable weights, enabling different situations to effect different combinations of content items from the different content selection processes.

### CROSS REFERENCE TO RELATED APPLICATION

This application claims the benefit of U.S. Provisional Application No. 63/698,987, filed Sep. 25, 2024, which is incorporated by reference in its entirety.

### BACKGROUND

Content items may be selected for presentation to users of an online system according to different systems and with different considerations. In many cases, user interfaces have specified regions for different content items retrieved according to different selection criteria. For example, some content items may be selected based on relevance to a search query, while additional content items may be selected based on additional engagement with the responding system or consideration of supplemental factors. The static presentation of content items in a display may improperly overweight content selected by one process over another and prevent effective mixture of content that effectively balances different considerations.

### SUMMARY

In accordance with one or more aspects of the disclosure, a joint impression scoring is applied to content items selected by different content selection processes of an online system. The joint impression scoring provides a unified scoring for the content items that enable comparison of content items for selection relative to presenting the items for impression. The joint impression scoring includes factors that evaluate content items according to different priorities with respect to presenting each content item, which may include an intrinsic value, a supplemental value, and an interaction value. The intrinsic value may describe a value to the online system for interaction with the content item (e.g., a value to the online system for purchase of the item). The supplemental value may describe additional value allocable to the content item that differs from (and supplemental to) the intrinsic value and may describe a value of presenting the content item from a separate content selection process. The interaction value may represent a value of the content item with respect to the user's expected preference for the content item and likelihood of interacting with the content item. The interaction value may thus indicate the relevance of the content item to a particular context for presenting the content item to the user, such as a user's search query. Combining the various types of factors in evaluating content items enables unified selection of content items that balance direct user interests with intrinsic and supplemental values for the content item. The different scoring factors may be weighted according to different weights that may be modified in different contexts. For example, the weights of the respective value types may be modified based on user features, display device, query entropy, and so forth.

After scoring content items selected by the different selection processes, the evaluation by the unified scoring is used to merge the items for presentation. The content items may be merged with a “head-of-list” process (comparing the top content item of from each selection process) or by re-ranking the different content item sets according to the unified scoring. The merged set of content items is then sent to a user device for presentation to the user. This enables the online system to optimize selection of content items from the content selected by different processes for presentation on the often limited available display positions on the user device.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIGS. 3A-C are example user interfaces for presenting content items to users of a user client device, in accordance with one or more embodiments.

FIG. 4 shows an example dataflow for generating a unified set of content items using multiple content selection processes, in accordance with one or more embodiments.

FIG. 5 illustrates example factors for determining a total impression score, in accordance with one or more embodiments.

FIG. 6 is a flowchart for a method of selecting content items for a user interface, in accordance with one or more embodiments.

### DETAILED DESCRIPTION

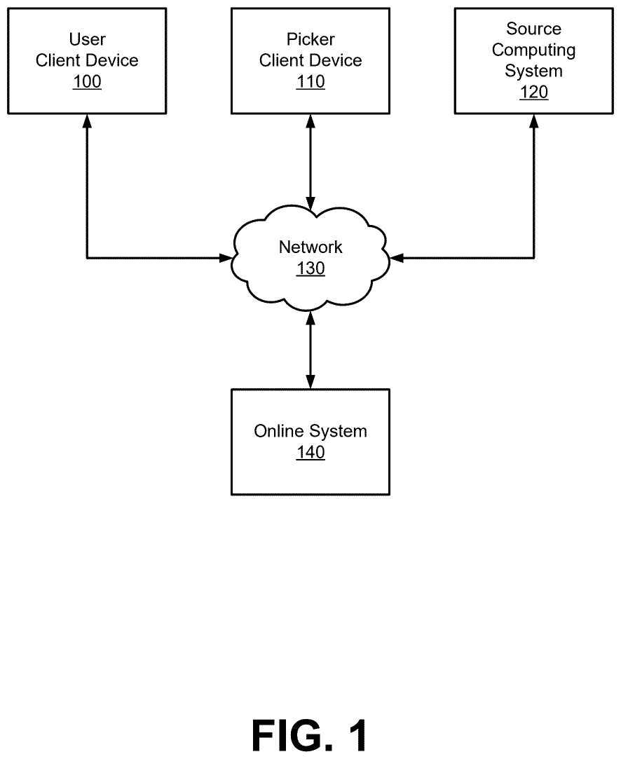

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a quick response (QR) code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

In some embodiments, the online system 140 selects content items for an interface to be provided to the user on the user client device 100. The content items may include, for example, items available to be added to an order. The user interface provided by the user client device 100 typically includes a limited number of locations (e.g., spaces or slots) on which content items may be presented. As discussed further below, the online system 140 initially identifies content items with two or more different content selection processes and then applies a joint scoring to dynamically select content items from these different content selection processes. The selected content items are then sent to the user client device 100 for presentation to the user of the user client device 100. The user may then interact with the content items for addition to an order or for other purposes.

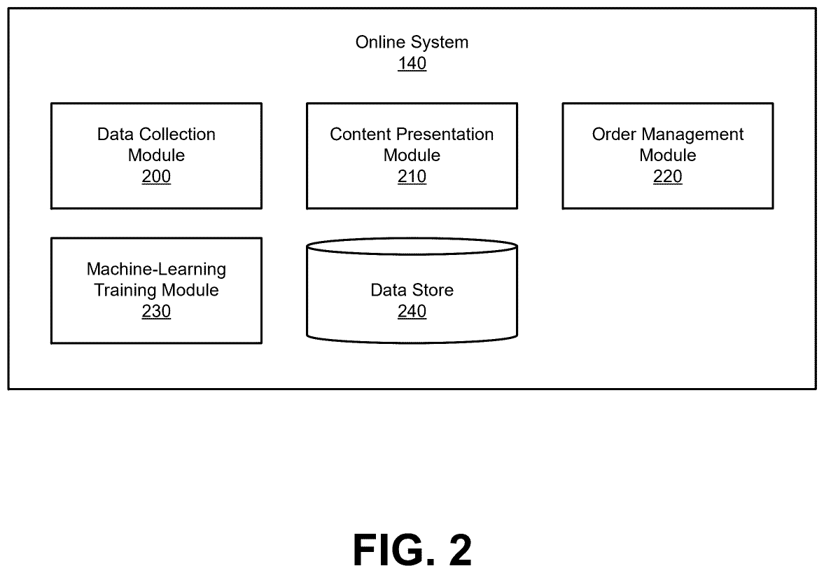

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with one or more embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

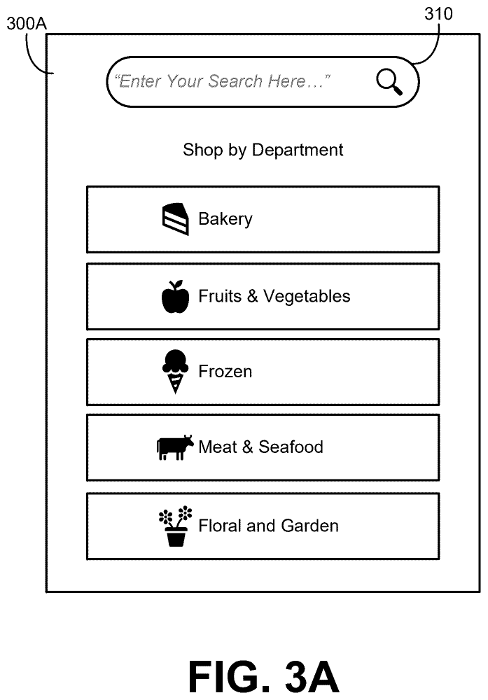

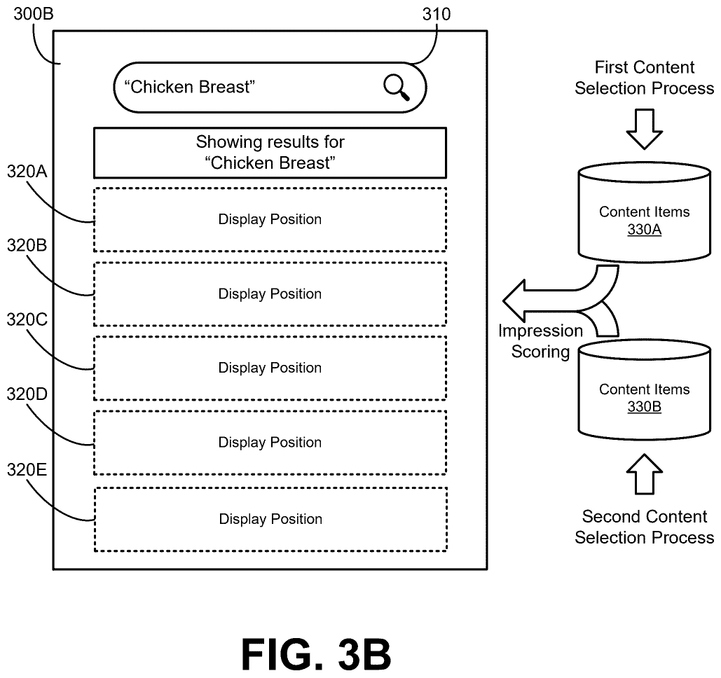

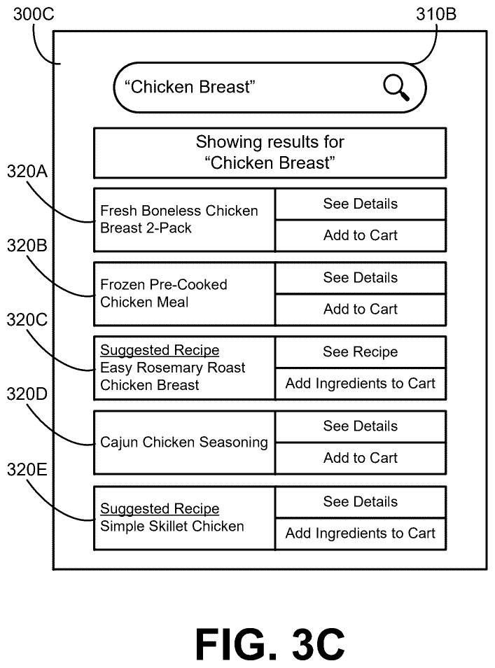

The content presentation module 210 may use multiple content selection processes to select items to include in the interface and present to the user. Rather than statically assign specific locations to the items output from each content selection process, the content presentation module 210 dynamically selects content items from each selection process by applying a joint impression scoring to the content items from each selection process, such that the joint impression scoring evaluates different factors and considerations for an impression of each content item. The different locations in the user interface may then be populated dynamically based on the joint impression scoring, enabling different proportions of content items from each content selection process at different times and under different conditions. The content selection process is further discussed below with respect to FIGS. 3-6.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIGS. 3A-C are example user interfaces for presenting content items to users of a user client device, in accordance with one or more embodiments. The interfaces 300A-C of FIGS. 3A-C show examples for an online system 140 providing for grocery ordering; additional embodiments include different types of content items selected for additional reasons as further discussed below. FIG. 3A shows an initial user interface 300A in which a user accesses the online system via the user client device. The user interfaces 300A-C may be generated and displayed to a user by the user client device based on information provided by an online system. As discussed further below, the online system may select content items for fulfilling a request for content items based on multiple content selection processes that are combined for the user interface based on a joint impression scoring. In the example of FIGS. 3A-3C, the content items are selected responsive to a query entered by a user in a query interface 310. In one or more additional embodiments, the online system selects content items in additional contexts and types of interfaces presented to the user. For example, the interface 300A of FIG. 3A includes categories of content items in a directory. In one or more embodiments, the selected content items may include selecting content items for directory as shown in FIG. 3A. For an online system providing grocery services, the different contexts and selected content items may also include selecting content items at different points of a user's purchasing process, for example, before creating an order (i.e., adding any items to a cart), when a user enters a search query, and after a user places an order with the online system.

When a user enters a search query in the query interface 310, the entered search query is sent to the online system, which receives the search query and selects content items to respond to the search query. As shown in FIG. 3B, the response to the search query may include a number of display positions 320A-E. In general, user devices and related displays include a limited amount of display space for presentation to the user. In responding to the search query, in general the display positions 320A-E in which content items may be presented are limited and may represent an ordering of selected content items. In this example, display positions 320A-E may typically be ordered, such that highest-scoring content is presented in display position 320A, a next content item in display position 320B, and so forth. In addition, in one or more embodiments, additional content items may be selected but not displayed until a user interacts with the interface 300B, for example by scrolling the interface to view additional results.

As discussed further below, content items to be selected for display in the display positions 320A-E are selected from a set of content items 330A and content items 330B that may be determined by different content selection processes. The content items 330A, B may represent different types of content items, or may be similar types of content items that are selected by differing processes. Rather than statically assign particular display positions 320A-E to different content selection processes (e.g., display positions 320A-C are filled with content items selected by the first content selection process and display positions 320D-E are filled with content items selected by the second content selection process), the display positions 320A-E are dynamically filled by the different content selection processes, such that in different circumstances, different proportions of content items from each content selection process are selected to fill the display positions 320A-E. To do so, a joint impression scoring is applied to the content items 330A, B to select content items based on the joint impression scoring. In this example, the first content selection process selects content items 330A that can be added to an order based on textual relevance to the search query, and the second selection process selects content items 330B as recipes that may be relevant to the search query.

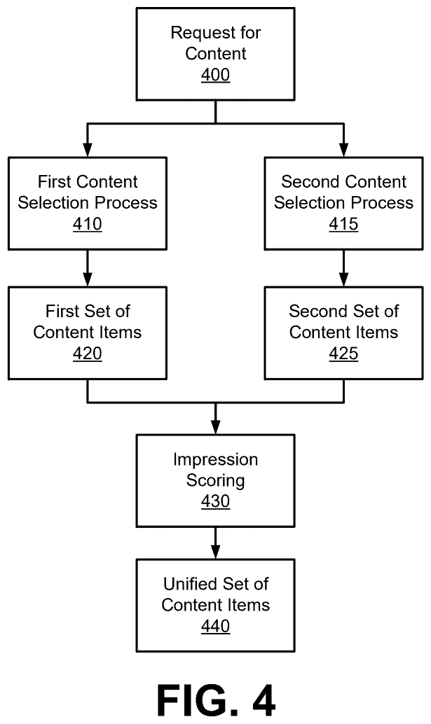

FIG. 3C shows an example selection of content items and populating the display positions 320A-E dynamically with content items from these different content selection processes. In this example, the items from content items 330A from the first selection process (items that can be added to an order) are selected for display positions 320A, B, D, and items from content items 330B from the second selection process (related recipes) are selected for display positions 320C, E. Further details regarding the selection processes and impression scoring are discussed with respect to FIGS. 4-6.

FIG. 4 shows an example dataflow for generating a unified set of content items using multiple content selection processes, in accordance with one or more embodiments. Initially, a request for content 400 is received from a user device for content items. The request for content 400 may include a search query including, for example, a text string. The request for content 400 may also be associated with a context, information about the user, and other data that may be used by content selection processes for identifying content. The online system may also identify a number of display positions available for display in the user interface for selected content items.

The request for content is initially processed by at least two different content selection processes, shown here as a first content selection process 410 and a second content selection process 415, that result in a respective first set of content items 420 and a second set of content items 425. The particular content items and content selection processes differ in various embodiments and may include content selection processes that select content from different sets of eligible content, different types of content, evaluate content items with different considerations, and so forth. In the examples below, the content selection processes may generally relate to an online system facilitating orders for pickers of grocery items, although different types of content selection processes may be used in different configurations. In general, the content selection processes may score content items according to respective scoring criteria and output an ordered set of content items that is typically a ranked ordering based on the respective scoring criteria. The content selection processes may include applying one or more computer models to one or more user representations and/or item representations to evaluate the content items for the received request. As such, the first set of content items 420 and second set of content items 425 are typically ordered (e.g., as a queue) according to the respective scoring criteria of the first content selection process 410 and the second content selection process 415.

In various situations, the first content selection process 410 select content items based on relevance of the content items to the request for content 400. The first content selection process 410 may score the content item for relevance based on various factors, such as a predicted likelihood of a user interacting with a content item if that content item is presented to the user. The likelihood of a user interacting with the content item may be based on the search query, context, user features, and so forth, and may be based on one or more outputs from trained computer models. A relevance score may be based on various factors, such as: a likelihood a user interacts with the content item (e.g., the user clicks on the content item); a likelihood of a subsequent user action after interacting with the content item (e.g., the user adds the content item to an order and completes an order); word/embedding similarity of a search query and a description of the item; prior user interactions related to the item or other items; and so forth.

The second content selection process 415 may include selecting the second set of content items 425 by another content selection process that differs from the first content selection process 410. The second content selection process 415 may include additional factors or considerations relative to the first content selection process 410, select content from a different set of eligible content, or evaluate content differently. For example, the second content selection process 415 may include different types of content, such as other types of content (e.g., recipes), content that may increase interactions with the online system in different ways (e.g., articles or videos for learning about items or other features of the online system), promoted items (e.g., items that a merchant has indicated for prioritization based on stock levels, potential spoilage, etc.), or sponsored items (e.g., items selected based in part on an auction or bidding algorithm). As such, in one or more embodiments, the first content selection process 410 selects content items based on relevance of the items to a search query and the second content selection process 415 selects content items at least in part based on sponsorship of items using a bidding system (which may also include consideration of a relevance score of the content item).

The first set of items 420 and second set of items 425 are combined to a unified set of content items 440 using an impression scoring 430. The impression scoring 430 provides a unified approach to assessing content items selected from the different content selection processes. As discussed below, the impression scoring may include factors that represent different priorities of the online system and may include priorities for different entities related to the online system. For example, one factor may preference user experience (e.g., by preferencing content items with a high predicted interaction rate), another factor may preference the online system (e.g., by preferencing content items with a high interaction value to the online system), while another factor may preference supplemental value sources (e.g., additional value sources such as different types of interactions with the online system or supplemental value from a sponsoring entity).

To generate the unified set of content items 440, the impression scoring 430 is applied to the content items of the first set of content items 420 and the second set of content items 425 to determine respective impression scores. In one or more embodiments, content items are selected from the first set of content items 420 and the second set of content items 425 by jointly ranking the respective content items according to the impression scoring 430 and selecting the highest-ranking content items for the unified set of content items 440.

In one or more embodiments, an order of content items within the respective first set of content items 420 and second set of content items 425 is preserved when selecting content items for the unified set of content items 440. In one or more embodiments, each set of content items 420, 425 is ordered and has a sequence (e.g., a list or queue) of content items in order of preference according to the respective content selection process. To maintain this ordering for the unified set of content items 440, the online system may evaluate the impression scoring 430 for the head-of-queue for each set of content items and select the next content item for the unified set of content items 440 from the head-of-queue, such that lower-ordered items in the first set of content items and second set of content items are not selected until they reach the respective head-of-queue.

By selecting content items based on the impression scoring and from content items selected by different content selection processes, the display positions for a user interface may be dynamically populated without rigidly specifying a number of content items to be selected from the different content selection processes. Rather, the particular number of content items can change based on the impression scoring, which may differ in different situations and with different content items in each set. In addition, as discussed further below, the impression scoring may include adjustable weights that may affect how different factors are combined to determine the impression score, enabling different evaluation and selection of content items from the different content selection processes under different conditions. After selecting the unified set of content items 440, the online system sends the unified set of content items 440 for display in the user interface.

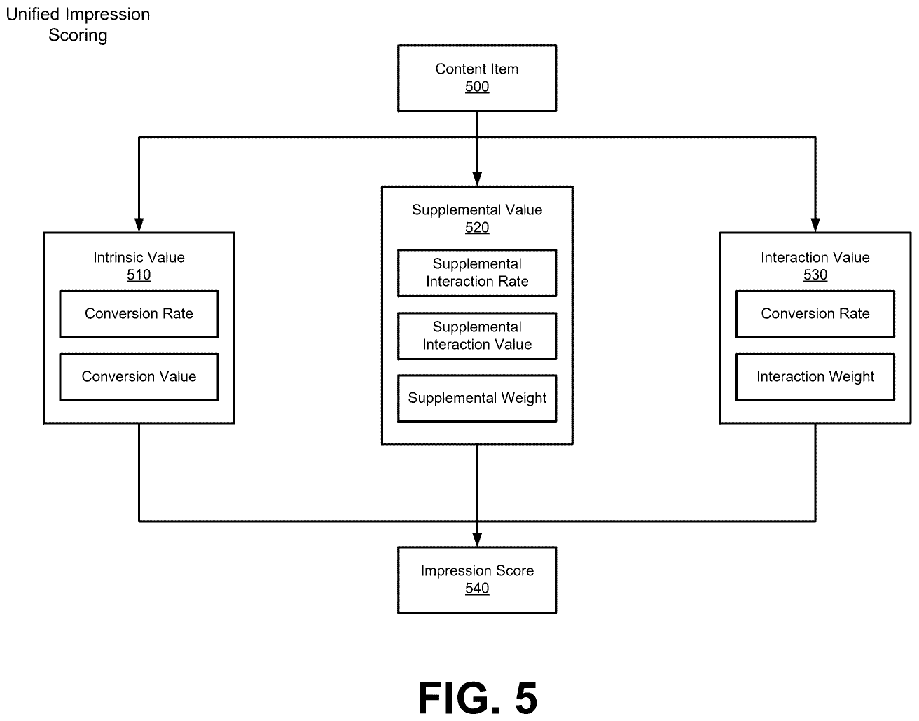

FIG. 5 illustrates example factors for determining a total impression score 540, in accordance with one or more embodiments. The impression score 540 may be determined by the online system for content items from multiple sets of content items, each generated by a different content selection process as discussed above. The impression score 540 may be determined by various types of factors and may include application of one or more computer models to predict various values used in the determination. The example factors of the impression score 540 shown in FIG. 5 include an intrinsic value 510, a supplemental value 520, and an interaction value 530. The different factors may be used to represent different interests in presenting the various types of content items, which may be related to different entities or aspects of the online system.

The intrinsic value 510 may represent a value of presenting a content item 500 from the perspective of a value to the online system. Particularly, in online systems where items are purchasable by users, the intrinsic value may include an evaluation of a value of the user selecting the related item for an order and “converting” by completing an order with the item. The conversion may thus represent an interaction with the item beyond selecting the item when presenting the item as one of the selected items, and may include subsequent interactions, such as reviewing item details, adding the item to an order, and so forth. As such, the intrinsic value 510 may include consideration of a conversion rate and a conversion value of the item. The conversion rate predicts the likelihood of the desired user interaction (e.g., a conversion) when the content item 500 is selected for the current user interface. The desired interaction may be an interaction subsequent to the user interacting directly with the content item on the user interface. That is, for a content item shown in FIG. 3C that includes a user interface element to “add to cart,” the desired interaction may include a subsequent action consider a conversion may include an interaction presented on the responsive to the content. The predicted interaction rate may be an output of a computer model based on various factors such as user features, item features, context, and so forth. The conversion value may represent a value to the online system for performing the conversion action, and for a conversion of an item in an order may represent, for example, a price at which the item is offered, a gross revenue, a profit, or other value of the item. In other contexts, the intrinsic value 510 may be other values assignable to the action performable by the user. For example, certain types of content items may not be purchased by the user (e.g., recipes or informational content) but may have an imputed value to the online system by increasing interactions with the online system and may differ from item to item. Although a particular conversion rate and conversion value are shown as examples, the intrinsic value 510 may be determined by various ways and with respect to different types of interactions associated with selection of the content item and a related value (each of which may be a result of a computer model prediction).

The supplemental value 520 may represent a value to the online system that may be derivable from different and/or alternate sources than the intrinsic value 510. For example, the supplemental value 520 may represent different aspects of the content item that may provide benefits to the online system in addition to or alternative to the conversion value of the intrinsic value 510. These may include values attributable to managing inventory of a warehouse (e.g., a value that promotes exhausting supply of a discontinued product), values for content items based on longer-term objectives of the online system (e.g., presentation of items associated with users increased tenure and use of the online system), values from third parties for promoting or sponsoring a particular content item, and so forth. In one or more embodiments, the supplemental value may be based on a bid, auction, or competitive process for identifying content items (e.g., when a content selection process includes a specified value from another entity for presenting the content item). In the example of FIG. 5, the supplemental value 520 is based on a supplemental interaction value and a supplemental interaction rate. The supplemental interaction rate may refer to a user interaction related to the content item, which may be the same or may be different from the conversion rate. In one example, the supplemental interaction rate is a user interaction with the content item when displayed on the user interface, such as a “click-through rate” with the content item. The supplemental interaction rate may also be determined based on a trained machine-learning model that predicts a rate of the user interacting with the content item. The supplemental interaction value is a value associated with the supplemental interaction, and may be, e.g., based on a value from one of the content selection processes. In one or more embodiments, the supplemental value 520 may be modified by an adjustable supplemental weight that may affect the relative contribution of the supplemental value 520 to the impression score 540.

The interaction value 530 provides a value related to the user for a content item of interest. This value may represent, for example, a separate value from the intrinsic value 510 and may use a different or the same interaction of the user with the item reflecting that the selected content item 500 was beneficial to the user. The action used to indicate interest for the user may be the same or different from the interaction for the intrinsic value 510. The conversion rate thus may be same conversion rate as used for the intrinsic value 510 or may be determined by evaluating a likelihood for another user action. As such, while the intrinsic value 510 may indicate a value to the online system, the interaction value 530 ensures that the user's preferences are not excessively affected by the intrinsic value 510. As with the supplemental value 520, the interaction value may also be affected by an adjustable interaction weight that affects the relative contribution of the interaction value 530 to impression score 540.

As noted above, the various components of the impression score 540 may be affected by weights that may be dynamically set. The weights may be set differently in different situations and based on various considerations. In the example of FIG. 5, two weights are shown, including a supplemental weight and an interaction weight. In one or more embodiments, different and/or additional weights may be used in different combinations to modify the respective contributions of the different components of the overall impression score 540. As the weights affect the contribution of different components to the impression score 540, different values of the weights may affect the selection of content items from the different sets of content items as shown in FIG. 4.

As examples, the adjustable weights for components of the impression score 540 may be adjusted based on user device type, user features, query entropy, interface context (e.g., a particular interface/webpage on which the content items are being placed), and so forth. For example, for different user device types, users may be differently able to navigate different types of items and may have a different number of content items that may be displayed at one time to the user, such that the weights may be modified to adjust the scoring and affect proportion of content items selected from each content item selection process. Similarly, when content items are selected based on a search query, the entropy of the resulting search results (i.e., content items selected by a selection process based on the search query) may be used to affect the weights. The entropy refers to a measure of the similarity of the search results, and such search results with relatively dissimilar items may be considered to have a higher entropy than search results with relatively similar items. Increased entropy in search results may reflect higher uncertainty or ambiguity in the user's intention in the search; as such, the adjustable weights (e.g., the interaction weight) may be increased to preference search results that may be more likely to be responsive to the query intent.

Similarly, the interface context may be used to modify the relative weight of intrinsic value and/or supplemental value according to the type of interface; when the user is viewing results related to a specific search, the relative weight of an interaction value 530 may be increased, while a broader search (e.g., viewing items within a category without a specific search query) may have a lower weight. Similarly, when a user has already placed an order (a post-checkout interface) or is viewing general items available, the intrinsic value and supplemental weight may be adjusted relatively high, while the interaction weight is relatively low.

The impression score 540 is determined by the online system by combining the various value factors for each content item 500. By using these various factors, the impression score 540 can assess the value of different content items from different content selection processes using a common evaluation process.

As one particular example in which the conversion rate for the intrinsic value 510 and conversion rate for an interaction value 530, the impression score ISᵢ for an item i may be determined by Equation 1:

$${IS}_{i} = {pCVR}_{i} \times {CV}_{i} + β \times {pSIR}_{i} \times {SIV}_{i} + α \times {pCVR}_{i} \qquad EQUATION 1$$

in which pCVRᵢ is a conversion rate for the item i,
CVᵢ is a conversion value for the item i,
pSIRᵢ is a supplemental interaction rate for the item i,
SIVᵢ is the supplemental interaction value for the item i,
α is an interaction weight, and
β is a supplemental weight. Equation 1 can also be written as:

$${IS}_{i} = {pCVR}_{i} \times ( {CV}_{i} + α ) + β \times {pSIR}_{i} \times {SIV}_{i} \qquad EQUATION 2$$

As shown in Equation 2, in this example, the interaction weight a may provide a balance to the conversion value, such that the user's interest in effective content items is not overly affected by selection based on other criteria. In one or more embodiments, the supplemental interaction rate SIRᵢ is a click-through rate for the item when presented on the interface, and the supplemental interaction value is a value (or cost) associated with an interaction on the interface (e.g., a click).

In one or more embodiments, the content selection processes may include a first content selection process based on item relevance to a search query and a second content selection process based on selection of sponsored content items including a bid and/or other value (typically from a third-party entity) determined in comparison with other content items in an auction or other selection process. In addition, the various items may be added to an order coordinated by the online system, such that a conversion value represents a value to the online system for fulfilling an order with the selected item. In these embodiments, the impression score 540 may be used to provide effective and dynamic blending of content items selected by these different processes, enabling sponsored content items to be effectively evaluated with search query results while also considering the user's interest in desired search results and considering the relative value of a conversion to the online system for the item. In these embodiments, the supplemental interaction value may be based on a value for the item output from the second content selection process based on the selection process (e.g., an auction). The supplemental interaction rate may be the click-through rate of the content item when presented on the user interface. In these example embodiments, the interests of the various entities—the user, the online system, and a sponsoring entity of a content entity—are effectively evaluated for each content item and enable a dynamic selection of content items from the different content selection processes. Particularly, the inclusion of an intrinsic value 510 and interaction value 530 along with relevant weights (e.g., an interaction weight) enables consideration of the intrinsic value (e.g., to the online system) and dynamic balancing of this value with the interaction value (e.g., to the user). As a result, the overall user interface is composed with dynamically-selected content items from organically-selected content items responsive to the search query (a first content selection process) and content items selected based, in part, on a sponsorship component (a second content selection process). This enables effective incorporation of sponsored content into search results with tunable weights.

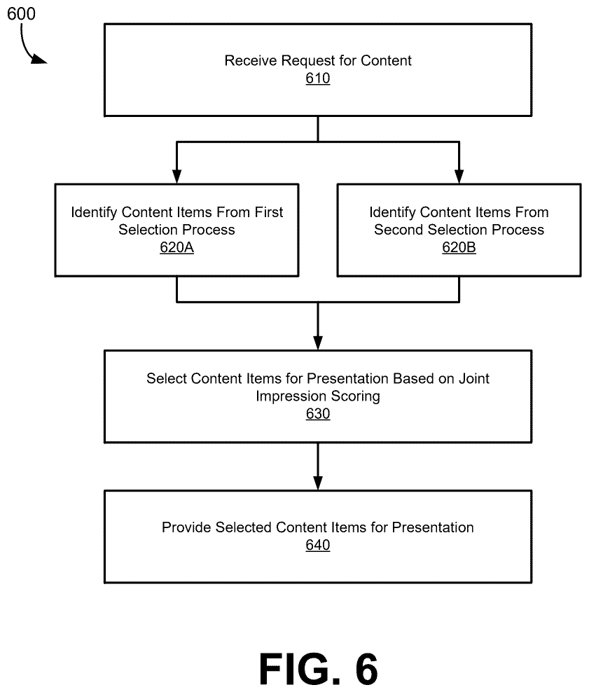

FIG. 6 is a flowchart for a method 600 of selecting content items for a user interface, in accordance with one or more embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

Initially, a request for content is received 610, which may be associated with a particular context or user interface on which to present content items for a user. The request for content may also include a search query for identifying relevant content items. As discussed above, the request for content may then be used to identify 620A first content items from a first selection process and identify 620B second content items from a second selection process. The first selection process may include, e.g., selecting content items based on relevance to the context and/or search query; the second selection process may include selecting content items with different and/or additional considerations. In one or more embodiments, the online system applies the first and/or second selection processes; in one or more embodiments, the online system may receive the identified 620A-B content items from one or more other systems that apply the first and/or second selection processes.

To select content items for the user interface, the content items from the first content items and second content items are evaluated with a joint impression scoring, which is used to select 630 content items based on the joint impression scoring. As discussed above, the joint impression scoring may be applied to multiple content items from each set of content items, or the joint impression scoring may be applied to the head-of-queue for each set of content items. As such, in one or more embodiments, the ordering of content items within the first set of content items and second set of content items may be preserved when selected for presentation based on the joint impression scoring. As discussed above, the joint impression scoring may include combining multiple components reflecting different value types, such as an intrinsic value, interaction value, and supplemental value, and may include one or more adjustable weights that may be set based on various characteristics. After selecting 630 the content items for presentation, the selected content items are provided 640 for display in an interface of the user device to respond to the received request 610.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that are issued on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving a request for content for a user of a user device;
identifying a first set of content items selected with a first selection process;
identifying a second set of content items selected with a second selection process;
selecting a unified set of content items from the first set of content items and the second set of content items with a joint impression scoring of respective content items based on an intrinsic value to an online system for user interaction with the content item and a supplemental value based on a bid value for the content item and an adjustable weight for combining the intrinsic value and the supplemental value; and
providing the unified set of content items to the user device for display to the user, causing the user device to display the unified set of content items.

2. The method of claim 1, wherein the intrinsic value or the supplemental value are based at least, in part, on a predicted interaction rate of the user with the content item determined by a predictive computer model.

3. The method of claim 1, wherein the joint impression scoring includes an interaction value to the user determined based on a relevance to the user of the content item.

4. The method of claim 1, wherein the request for content includes a search query provided by the user and the first selection process selects the first set of content items based on a relevance to the search query.

5. The method of claim 4, wherein the second selection process includes selecting the second set of content items based on one or more bids for providing sponsored content items to the user.

6. The method of claim 1, wherein the first set of content items and the second set of content items are ordered lists and the unified set of content items is determined by selecting from respective heads of the ordered lists based on the joint impression scoring.

7. The method of claim 1, further comprising setting the adjustable weight based on a type of the user device, one or more user characteristics, or a context of the request.

8. The method of claim 1, further comprising setting the adjustable weight based on an entropy of the first set of content items.

9. A system, comprising:
a processor that executes instructions; and
a non-transitory computer-readable medium having instructions executable by the processor for:
receiving a request for content for a user of a user device;
identifying a first set of content items selected with a first selection process;
identifying a second set of content items selected with a second selection process;
selecting a unified set of content items from the first set of content items and the second set of content items with a joint impression scoring of respective content items based on an intrinsic value to an online system for user interaction with the content item and a supplemental value based on a bid value for the content item and an adjustable weight for combining the intrinsic value and the supplemental value; and
providing the unified set of content items to the user device for display to the user, causing the user device to display the unified set of content items.

10. The system of claim 9, wherein the intrinsic value or the supplemental value are based at least, in part, on a predicted interaction rate of the user with the content item determined by a predictive computer model.

11. The system of claim 9, wherein the joint impression scoring includes an interaction value to the user determined based on a relevance to the user of the content item.

12. The system of claim 9, wherein the request for content includes a search query provided by the user and the first selection process selects the first set of content items based on a relevance to the search query.

13. The system of claim 12, wherein the second selection process includes selecting the second set of content items based on one or more bids for providing sponsored content items to the user.

14. The system of claim 9, wherein the first set of content items and the second set of content items are ordered lists and the unified set of content items is determined by selecting from respective heads of the ordered lists based on the joint impression scoring.

15. The system of claim 9, wherein the instructions are further executable for setting the adjustable weight based on a type of the user device, one or more user characteristics, or a context of the request.

16. The system of claim 9, wherein the instructions are further executable for setting the adjustable weight based on an entropy of the first set of content items.

17. A non-transitory computer-readable medium, the non-transitory computer-readable medium comprising instructions executable by a processor for:
receiving a request for content for a user of a user device;
identifying a first set of content items selected with a first selection process;
identifying a second set of content items selected with a second selection process;
selecting a unified set of content items from the first set of content items and the second set of content items with a joint impression scoring of respective content items based on an intrinsic value to an online system for user interaction with the content item and a supplemental value based on a bid value for the content item and an adjustable weight for combining the intrinsic value and the supplemental value; and
providing the unified set of content items to the user device for display to the user, causing the user device to display the unified set of content items.

18. The computer-readable medium of claim 17, wherein the intrinsic value or the supplemental value are based at least, in part, on a predicted interaction rate of the user with the content item determined by a predictive computer model.

19. The computer-readable medium of claim 17, wherein the joint impression scoring includes an interaction value to the user determined based on a relevance to the user of the content item.

20. The computer-readable medium of claim 17, wherein the request for content includes a search query provided by the user and the first selection process selects the first set of content items based on a relevance to the search query.
